(19) United States
(12) Patent Application Publication
(10) Pub. No.: US 2022/0292747 A1
(43) Pub. Date: Sep. 15, 2022

(54) METHOD AND SYSTEM FOR PERFORMING GTL WITH ADVANCED SENSOR DATA AND CAMERA IMAGE

(71) Applicant: NEXTBOX CO., LTD., Seongnam-si (KR)

(72) Inventors: Yeong Hun KIM, Goyang-si (KR); Jaechun NOH, Yongin-si (KR)

(21) Appl. No.: 17/527,273

(22) Filed: Nov. 16, 2021

(30) Foreign Application Priority Data
Mar. 10, 2021 (KR) 10-2021-0031353

(51) Int. Cl. G06T 11/60; B60R 11/04; H04N 5/232

(52) U.S. Cl. CPC G06T 11/60; B60R 11/04; H04N 5/23229; B60R 2300/301; G06T 2210/61

(57) ABSTRACT

The present invention discloses a system and method for performing auto-labeling by correcting image data captured by a camera based on data measured by an advanced sensor.

### FIELD OF THE INVENTION

The present invention relates to a method and system for performing Ground Truth Auto-Labeling (GTL) with advanced sensor data and camera image. In particular, the present invention relates to a method and system of performing GTL that can dramatically reduce time and cost of verifying reliability that in mobility and high-tech industries.

### BACKGROUND OF THE INVENTION

In the mobility and advanced sensor industries such as autonomous driving, reliability verification is very important. In order to utilize Advanced Driver-Assistance System (ADAS) and sensor development, it is necessary to perform a step of classifying objects, such as people, cars, street trees, lanes, and the like. In this instance, GTL is essentially required for verification. For example, autonomous driving needs object recognition technology to detect people, signals, and other vehicles. In order to create an object recognizer, a learning data set labeled with the shape and type of each object is needed. In other words, all images or videos must be analyzed and interpreted in advance to identify the object, and this process is commonly referred to as GTL. Labeled data is also used as a basis for evaluation of algorithm in ADAS and autonomous driving.

GTL is a tremendously time-consuming task that requires direct labeling for each frame of image information of other object. Recently, GTL service has been used in a way of targeting approximate other object based on artificial intelligence. However, the service provider must prepare the videos and upload them to the cloud of client company in advance, and there is also a cost burden for the client company to use the large-capacity storage cloud. In addition, since the auto-labeling targeting technology does not yet perfectly work with 100% accuracy, a human operator is secondarily needed for additional inspection and correction. In order to increase the accuracy based on artificial intelligence, the data that was labeled in the service cloud must be stored and used as big data. However, as the amount of data increases, the cost of using the cloud and services increases.

In addition, since the GTL of the image targets only the image, when mutual verification with advanced sensors such as lidar and radar is required, verification must be performed twice or more, performing classification and time matching of image data and sensor data, respectively. These processes are time-consuming and may be additional burdens for the system.

Therefore, in order to perform GTL quickly and accurately, it is necessary to have a process of matching data from an advanced sensor such as a radar and an image captured by a camera at once. The present invention has been devised based on this idea.

Korean Patent Publication No. 10-2020-0096096 regarding a combination of a radar and a camera discloses a method for efficiently allocating resources during autonomous driving by generating determination data for autonomous driving with reference to video data captured by one or more cameras installed in a vehicle using a computing device, acquiring situational data representing a change in the surrounding situation of a driving vehicle, and using reinforcement learning based on the data above.

Korean Patent Publication No. 10-2019-0070760 discloses a technology for acquiring information related to at least a portion of a road environment, traffic, or road curvature based on a camera that acquires image data of the surrounding environment of a vehicle, and a radar that acquires data of other vehicles and adjusting a parameter for determining a cut-in intention of a nearby vehicle driving in a second lane based on the acquired information.

Korean Patent Publication No. 10-2019-0060341 provides a radar and camera fusion system including an image processor that obtains a first detection information of a target in a current time interval from a received radar signal, that corrects a prediction value obtained in the previous time section as feedback, set a region of interest (ROI) in the image based on the estimation information of the distance, velocity, and angle of the target, that acquires a second detection information of the target in the current time interval within the region of interest, and that finally outputs the estimation information of the x-axis distance, y-axis distance, and velocity of the target with the minimized error.

However, these previous patents disclose general technologies of determining the predicted path of surrounding vehicle based on radar information, or performing a process comprising of correcting the past information with the current data and updating the current information in real time. Thus, detailed description regarding obtaining a matched image and data by combining data obtained by an advanced sensor such as radar and an image acquired by a camera is not disclosed.

### Technical Problem

Therefore, the present invention has an object to provide a GTL method and system that embody a process of matching data of an advanced sensor with an image captured by a camera in order to perform GTL quickly and accurately.

### SUMMARY OF THE INVENTION

To achieve the object mentioned above, the present invention provides a GTL system comprising: a sensor object data generating unit generating object data based on data of a sensor information receiving unit, a camera image data generating unit generating image data based on data of a camera information receiving unit, an object and image data synthesizing unit synthesizing the object data and the image data based on the same coordinate system and generating composite data, and an auto-labeling unit forming labeling data by correcting the composite data to be matched.

The object data may be a data that can be displayed as an image of the object based on the object's distance, speed, and size information provided by the sensor, and that is generated separately from an actual image of the object that is captured by the camera.

The auto-labeling unit may define a region of interest including the object shown in the object data and the object shown in the image data, specify the object of the object data by identifying threshold of the object of the object data through an image binarization technique, determine a central coordinate C1 based on the specified object, move the central coordinate C1 to a predetermined central coordinate C2 of the image data, and form the labeling data by correcting boundary, size, and angle of the image data based on the object data.

The sensor may be radar, lidar, or an ultrasonic sensor installed on an autonomous driving vehicle, and objects that can be auto-labeled may include any object or obstacle such as lanes, traffic lights, street trees as well as people and vehicles.

The GTL system may determine a model of another vehicle shown in the region of interest, by estimating an overall length of the vehicle based on an overall width and an overall height measured in the labeling data.

In addition, the present invention provides a method for performing labeling by synthesizing data of a sensor and image of a camera, the method comprising steps of: receiving sensor information from a radar information receiving unit, and generating object data based on the sensor information; receiving camera information from a camera information receiving unit, and generating image data based on the image data, while receiving sensor information and generating object data; projecting and synthesizing the object data and the image data with automatic time-matching, and generating a composite data, and generating labeling data by correcting the composite data.

The step of correcting the composite data may include steps of: defining a region of interest including the object shown in the object data and the object shown in the image data, specifying the object of the object data by identifying threshold of the object of the object data through an image binarization technique, and determining a central coordinate based on the specified object, and moving the central coordinate to a predetermined central coordinate of the image data, and correcting boundary, size, and angle of the image data based on the object data.

### Advantageous Effects

Along with an effect of camera image labeling, the GTL system of the present invention can simultaneously perform detection of actual advanced sensor information such as speed, distance, size of surrounding objects and camera recognition and can verify reliability, thereby reducing time and cost and enabling more advanced GTL auto-labeling.

In addition, since the GTL system of the present invention applies automatic time matching to camera information based on advanced sensor information such as radar and projects it to camera information for matching and verification without additional information processing, the GTL auto-labeler can be performed quickly and efficiently.

### BRIEF DESCRIPTION OF THE DRAWINGS

FIG. 1 is a block diagram of a GTL system of the present invention.

FIG. 2 is a flow chart illustrating an operation flow of the GTL system of the present invention;

FIG. 3 is a flow chart specifically illustrating each step of a correction process of the present invention;

FIG. 4A is a drawing conceptually illustrating an example of object data;

FIG. 4B is a drawing conceptually illustrating an example of image data;

FIG. 4C is a drawing conceptually illustrating composite data generated by projecting and overlapping object and image data;

FIG. 4D is a drawing illustrating generation of labeling data, and

FIG. 5 is an example of a photograph of a display including the labeling data produced using the GTL system of the present invention.

### DETAILED DESCRIPTION EMBODIMENTS OF THE INVENTIONS

Each embodiment according to the present invention is merely an example for assisting understanding of the present invention, and the present invention is not limited to these embodiments. The present invention may comprise a combination of at least any one of individual components and individual functions included in each embodiment.

Methods for recognizing objects include a camera, an advanced sensor, and the like. When the recognition tool changes, the collected information also changes. Accordingly, each tool has pros and cons in recognizing and analyzing objects from the collected data. For example, since radar collects information through radio waves, it collects information such as speed, distance, angle, and size of an object, but cannot capture the object accurately. On the other hand, a camera can capture an object more accurately, but it is vulnerable to environmental factors, such as bad weather. In addition, information regarding speed, distance, and size collected by a camera is less accurate than that of radar. However, if the advanced sensor and the camera are installed to face toward the same direction, the collected information is different, but the view of the object is the same.

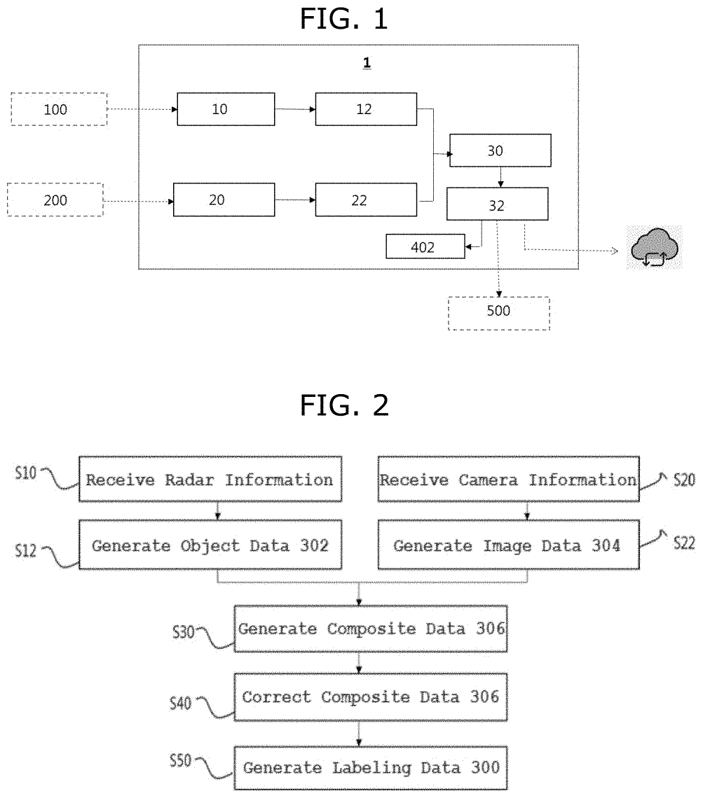

Based on this perspective, the GTL system 1 of the present invention is connected to a radar 100 and a camera 200 as shown in FIG. 1.

In the description below, the radar 100 is one embodiment of an advanced sensor. The present invention does not directly acquire an image captured by a capturing tool such as radar and lidar based on 3D or 4D information and an ultrasonic sensor using ultrasound. In addition, other types of sensors measuring speed, distance, and size of an object may be applied to the present invention. The camera is also one embodiment of an image capturing device, and the any image capturing device may be used in the present invention.

The GTL system 1 includes a radar information receiving unit 10 that receives data from the radar 100 and a camera information receiving unit 20 that receives data from the camera 200. Information received from the radar 100 is at least speed, distance, and size of a certain object. For example, if radar is used, the certain object includes any object and environment that can receive and transmit radio waves of the radar, such as people, other vehicles, lanes, traffic lights, signs, and stationary objects. The information received from the camera 200 is image data acquired by an image capturing device such as a lens. In general, the range of image acquired by an image capturing device is different from that of data acquired by radar.

The GTL system 1 of the present invention includes a radar object data generating unit 12 that generates object data 302 based on the data of the radar information receiving unit 10, and a camera image data generating unit 22 that generates image data 304 based on the data of the camera information receiving unit 20. An object and image data synthesizing unit 30 synthesizes the object data 302 and the image data 304 based on the same coordinate system, thereby generating composite data 306. An auto-labeling unit 32 produces labeling data 300 by correcting the composite data 306 through a process for matching the composite data 306. The process will be described in more detail later. The labeling data 300 may be displayed on an external display device 500 through an output unit, and may be stored in an internal storage device 402 and the cloud at the same time. The external display device 500 may be included in the GTL system 1.

FIG. 2 is a flow chart illustrating a process of auto-labeling the radar-based data and the camera-based data that is performed by the GTL system 1 of the present invention.

First, the GTL system 1 receives radar information from the radar information receiving unit 10, S10. Then, the object data 302 is generated based on this radar information data S12.

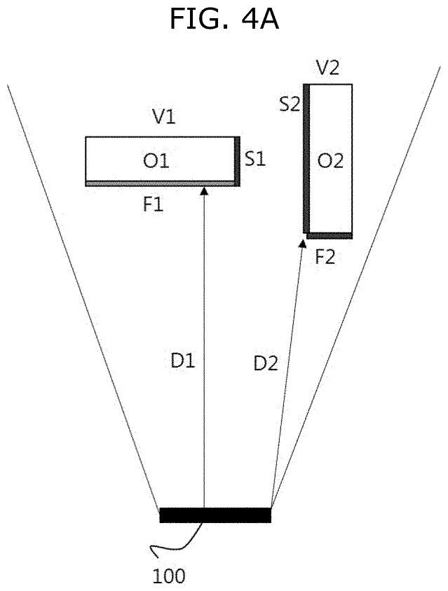

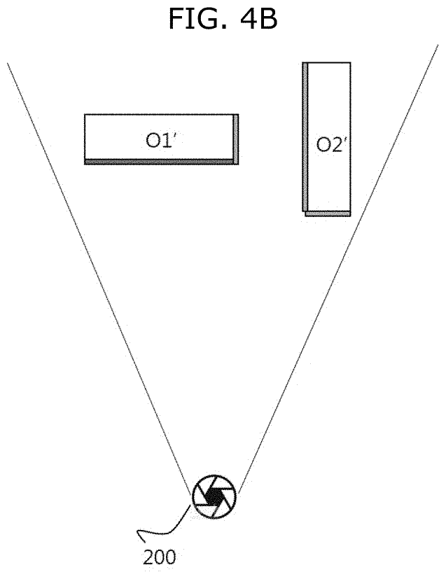

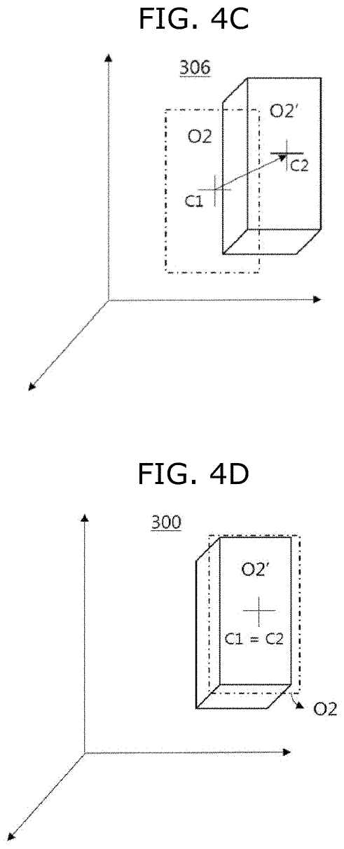

FIG. 4A illustrates an example of the object data 302 generated through this process. The object data 302 is RAW data or image data that can be displayed as an image of the object based on the object's distance, speed, size, and angle information which are provided by the radar information. In the embodiment illustrated in FIG. 4A, the radar information includes information regarding two objects O1, O2, which are in the detection range of the radar 100. In this case, the radar information includes information are the front size information F1, F2, the side size information S1, S2, the distance D1, D2 to the vehicle equipping with the GTL system 1, and the speed V1, V2.

While steps S10, 12, the GTL system 1 receives camera information from the camera information receiving unit 20, S20. Then, the image data 304 is generated based on this camera information data S22. The image data 304 includes images directly representing objects O1′, O2′ as shown in FIG. 4B, as is well known to those skilled in the art.

Then, the GTL system 1 of the present invention projects and synthesizes the object data 302 and the image data 304 to generate the composite data 306, S30. The same reference axis, the same coordinate system, is used for matched synthesis of the two data. The object data 302 is converted into a graphic data format to be synthesized with the image data 304.

The radar information and the camera information are automatically time-matched and accordingly, the object data 302 and the image data 304 in the same time period are synthesized.

FIG. 4C is a drawing conceptually illustrating the composite data 306 generated by projecting and overlapping the object data 302 and image data 304. In general, objects shown in the composite data 306 do not match. Since the image information obtained only from the camera 200 can be viewed only after additional steps of processing and analysis, it is necessary to label and categorize each object shown in the image information during verification. In addition, although the size of an object is constant, the image obtained by the camera 200 displays a near object to appear large and a distant object appear small. In other hand, compared to the image information of the camera 200, the radar 100 is relatively accurate in terms of verifying basic information such as distance and speed. Therefore, the present invention performs a process of correcting the composite data 306 in order to utilize the advantages of each device S40.

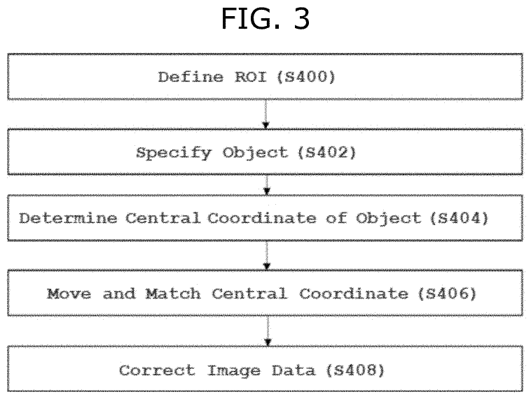

FIG. 3 is a flow chart specifically illustrating each step of a correction process of the present invention.

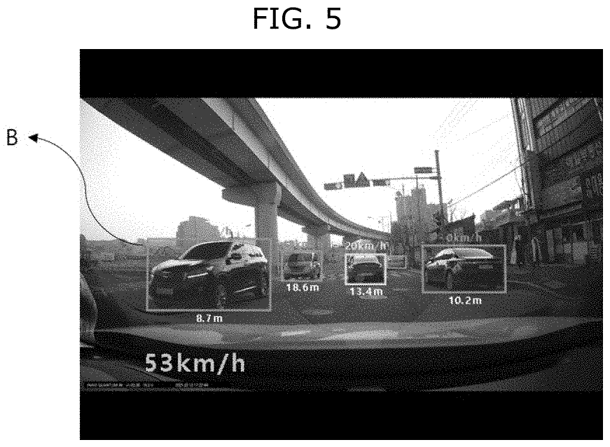

First, a region of interest ROI including the object O2 of the object data 302 and the object O2′ of the image data 304 is defined S400. An example of an ROI is illustrated in FIG. 5.

Next, the object O2 is specified from all possible planes by identifying the threshold of the object O2 through an image binarization technique S402. The image binarization technique has advantages that can identify other objects and also quickly classify lanes, roads, vehicles, and background in image, thereby enabling various classification and quick verification.

Then, a central coordinate C1 is determined based on the specified object O2, S404, and the central coordinate C1 of the object O2 is moved to a predetermined central coordinate C2 of the object O2′, S406. The predetermined center coordinate C2 of the object O2′ is easily determined from the image information of the camera 200. The process above is illustrated in FIG. 4D.

After matching the two central coordinates C1, C2, all data such as boundary, size, and angle of the image data 304 are corrected based on the object data 302 provided by the radar 100, S408. In addition, other than the objects O2, O2′, the GTL system also searches surrounding environments or other objects, and their positions are corrected through the process mentioned above.

In the above process, the corrected data is finally generated as the labeling data 300, S50, as shown in FIG. 2. The labeling data 300 may be stored in the internal storage device 402 and the cloud, and can be used whenever necessary.

In some embodiments, the present invention may further include a step of comparing multiple objects with each other in order to increase the accuracy of matching. In this case, the information regarding multiple objects may be collected by the radar 100, and have similar shape and size.

As described above, the GTL system 1 of the present invention projects and synthesizes the data of an advanced sensor, such as the radar 100, with the image information captured by the camera 200 in terms of “image”, and overcomes the technical limitation of the image captured by the camera 200 based on the data information of the radar 100. Accordingly, time and cost for using GTL can be drastically reduced, and reliability can be improved.

FIG. 5 is an example of a photograph of a display 500 including the labeling data 300 produced using the GTL system 1 of the present invention. In the image, an object can be checked with a labeling box B whether it is recognized, and also, information such as speed, distance, and size can be checked and matched to prove reliability. In contrast, the conventional GTL displays only a labeling box, and verification of sensor data is not shown.

The GTL system 1 of the present invention is a GTL auto labeler that automatically time-matches the camera information based on the radar information without a separate processing, thereby providing high-speed operation and effectiveness.

Meanwhile, considering current technology level, the error of 4D radar is approximately 10 cm. In bad weather conditions where it is not visible at all through a camera and lidar, radar can perform detailed classification of large cars, medium-sized cars, small cars, motorcycles, and the like, and accordingly, it is possible to estimate the type of vehicle even in bad weather conditions.

Furthermore, the specific type of vehicle can be estimated. For example, in the case of a hit-and-run accident on a foggy and dark day, the specific type of vehicle of the hit-and-run perpetrator can be roughly estimated through artificial intelligence learning from the technology above. For example, since the radar is only visible in 2D, when the vehicle is seen in front, the overall with and the overall height of the vehicle can be measured with high accuracy. However, the overall length may be difficult to be measured. In order to solve this problem, by storing big data of overall width and overall height of each specific vehicle in memory of the system in advance, overall length can be predicted only from overall width and overall height of a vehicle. For example, the overall width of vehicle X is 1,875 mm, the overall height is 1,470 mm, the overall width of vehicle Y is 1,900 mm, the overall height is 1,490 mm, the overall width of vehicle Z is 1,825 mm, and the overall height is 1,435 mm. By learning this data based on artificial intelligence that matches the big data, the vehicle information data matches, and the model and manufacturer of vehicle X can be automatically detected. This is an example for assisting understanding. In fact, there are various cases where estimating other features with the width and height can be utilized, and it is not limited to tracking vehicle.

The scope of the present invention described above is not limited to autonomous vehicle. It can be applied to all industries that require labeling and reliability by recognizing and photographing objects, such as drones, airplanes, missiles, smart logistics, CCTV, and smart cities, using advanced sensors and cameras.

It is apparent that the scope of the present invention extends to the same or equivalent as the appended claims described below.

What is claimed is:

1. A Ground Truth Labeling (GTL) system for synthesizing data of a sensor and image of a camera, the GTL system comprising:
a sensor object data generating unit generating object data based on data of a sensor information receiving unit,
a camera image data generating unit 22 generating image data based on data of a camera information receiving unit,
an object and image data synthesizing unit synthesizing the object data and the image data based on the same coordinate system and generating composite data, and
an auto-labeling unit forming labeling data by correcting the composite data to be matched,
wherein the object data is a data that can be displayed as an image of the object based on the object's distance, speed, and size information provided by the sensor, and that is generated separately from an actual image of the object that is captured by the camera,
wherein the auto-labeling unit defines a region of interest including the object shown in the object data and the object shown in the image data, specifies the object of the object data by identifying threshold of the object of the object data through an image binarization technique, determines a central coordinate C1 based on the specified object, moves the central coordinate C1 to a predetermined central coordinate C2 of the image data, and forms the labeling data by correcting boundary, size, and angle of the image data based on the object data.

2. The GTL system of claim 1, wherein the sensor is radar, lidar, or an ultrasonic sensor installed on an autonomous driving vehicle.

3. The GTL system of claim 2, wherein the GTL system determines a model of another vehicle shown in the region of interest, by estimating an overall length of the vehicle based on an overall width and an overall height measured in the labeling data.

4. A method for performing labeling by synthesizing data of a sensor and image of a camera, the method comprising steps of:
receiving sensor information from a radar information receiving unit, and generating object data based on the sensor information;
receiving camera information from a camera information receiving unit, and generating image data based on the image data, while receiving sensor information and generating object data;
projecting and synthesizing the object data and the image data with automatic time-matching, and generating a composite data, and
generating labeling data by correcting the composite data,
wherein the step of correcting the composite data including steps of:
defining a region of interest including the object shown in the object data and the object shown in the image data;
specifying the object of the object data by identifying threshold of the object of the object data through an image binarization technique, and determining a central coordinate based on the specified object, and
moving the central coordinate to a predetermined central coordinate of the image data, and correcting boundary, size, and angle of the image data based on the object data.
